(19) United States
(12) Patent Application Publication
(10) Pub. No.: US 2012/0319638 A1
(43) Pub. Date: Dec. 20, 2012

(54) ADJUSTMENT DEVICE

(75) Inventors: Bernhard Ritter, Pforzheim (DE); Dejan Djordjevic, Stuttgart (DE)

(73) Assignee: Dr. Ing. h.c. F. Porsche Aktiengesellschaft, Stuttgart (DE)

(21) Appl. No.: 13/525,702

(22) Filed: Jun. 18, 2012

(30) Foreign Application Priority Data
Jun. 20, 2011 (DE) 102011051184.9
Jul. 15, 2011 (DE) 102011051877.0

(51) Int. Cl. G05D 3/12

(52) U.S. Cl. 318/626; 318/469

(57) ABSTRACT

An adjustment device in the automotive field, having a fixed guide element and an adjustment element which is movably arranged with respect thereto and which has a referencing element, having an EC motor which drives the adjustment element within an adjustment travel, and having a control unit with an actuator for the EC motor, wherein the adjustment travel is bounded by a first and a second end point which are respectively arranged within a first and a second capture region, wherein at least one mechanical end stop is provided which is arranged outside the adjustment travel.

### CROSS-REFERENCE TO RELATED APPLICATIONS

This U.S. patent application claims priority to German Patent Application DE 10 2011 051 184.9, filed Jun. 20, 2011 and German Patent Application DE 10 2011 051 877.0, filed Jul. 15, 2011, both of which are incorporated by reference herein in their entirety.

### FIELD OF THE INVENTION

The invention relates to an adjustment device in the automotive field having a fixed guide element and an adjustment element which is movably arranged with respect thereto and which has a referencing element, having an EC motor which drives the adjustment element within an adjustment travel, and having actuation means for the EC motor, wherein the adjustment travel is bounded by a first and a second end point which are respectively arranged within a first and a second capture region. The adjustment device may be employed in an adjustable vehicle seat.

### BACKGROUND OF THE INVENTION

Such an adjustment device is known from DE 20 221 068 U1, which is incorporated by reference herein. This document discloses an adjustment device which is suitable, in particular, as a seat adjustment means. For this purpose an adjustment element is provided which can be driven with respect to a guide element by means of an EC motor (e.g., a brushless DC electric motor). The adjustment device furthermore has a first and a second mechanical end stop which define an adjustment travel for the adjustment element. What are referred to as protective stop points are provided spaced apart from these mechanical end stops within the adjustment travel, which protective stop points bring about a reduction in the adjustment energy, triggered by actuation means, when the adjustment element travels over said protective stop points. It is thereby ensured that the mechanical end stops are not subjected to excessively high mechanical loading by the impacting of the adjustment element. However, even with the reduction in the loading when the impact occurs, the end stops are subjected to continuous loading. Accordingly, the mechanical end stops are of solid design, which brings about an increase in weight. Furthermore, the adjustment element and the associated EC motor can also be damaged by impacting against the mechanical end stop.

### SUMMARY OF THE INVENTION

Disclosed herein is an adjustment device, a method for standardizing an adjustment device, and a method for re-standardizing an adjustment device, which avoid the abovementioned disadvantages.

According to aspects of the invention, at least one mechanical end stop is provided which is arranged outside the adjustment travel. This ensures that in the normal operating mode the adjustment element is moved only between the first and the second end points. The adjustment element therefore no longer impacts against the mechanical end stop during the normal operating mode.

A particularly advantageous embodiment is characterized in that the actuation means are configured in such a way that if the adjustment element is located in a capture region, it is possible to start the EC motor only in the direction of the opposite end point. This ensures in a particularly simple and cost-effective way that, even when there is a short distance between the adjustment element and the mechanical end stop, the actuation means are configured in such a way that power limitation of the EC motor is provided within a capture region.

Furthermore, disclosed herein is a method for standardizing such an adjustment device, wherein no referencing data are stored. The method describes the following steps: a referencing mode is selected in the control unit, the direction of rotation of the EC motor, the adjustment travel for the adjustment element, a distance of the adjacent end point from the mechanical stop and the capture regions for the end points are defined and stored for a referencing run. The referencing run of the adjustment element is started by triggering an operator control switch, the adjustment element is moved up to the mechanical end stop, as a result of which the EC motor is blocked, the direction of rotation of the EC motor is changed, the adjustment element is moved by the distance, the first end point is stored, the second end point is calculated on the basis of the adjustment travel and stored, the capture regions are assigned to the end points and stored, and the referencing run is terminated. This method for standardizing an adjustment device provides the advantage that only one mechanical end stop is then provided in principle. This gives a considerable saving in weight. A particular advantageous method for standardizing such an adjustment device is defined by the fact that if no referencing data are stored, a first power limitation for the entire referencing run is defined. This ensures that in the delivery state the EC motor of the adjustment device cannot be used with the full force. Accordingly, the at least one end stop should also be embodied less robustly since it cannot be loaded with the full torque of the motor. Furthermore it may be advantageous for a second power limitation to be defined for reaching the mechanical end stop.

Furthermore, disclosed herein is a method for re-standardizing an adjustment device, wherein referencing data are stored. This method is defined by the following steps: the referencing run of the adjustment element is started by triggering an operator control switch, the adjustment element is moved up to the end point and the EC motor is switched off, the operator control switch is actuated at least once in the direction of the closest end stop. The adjustment element is moved up to the mechanical end stop, as a result of which the EC motor is moved, the direction of rotation of the EC motor is changed, the adjustment element is moved by the distance, the first end point is stored, the second end point is calculated on the basis of the adjustment travel and stored, the capture regions are assigned to the end points and stored, the referencing run is terminated. This provides a simple re-standardizing method in which likewise only a mechanical end stop is used.

### BRIEF DESCRIPTION OF THE DRAWING FIGURES

An exemplary embodiment of the invention is illustrated in the drawing and will be described below. In the drawing:

FIG. 1 shows a motor vehicle seat having a plurality of adjustment devices, and

FIG. 2 is a schematic view of a guide element of an adjustment device according to aspects of the invention for longitudinal adjustment of a motor vehicle seat with the parameters to be stored in the control unit.

### DETAILED DESCRIPTION OF THE DRAWING FIGURES

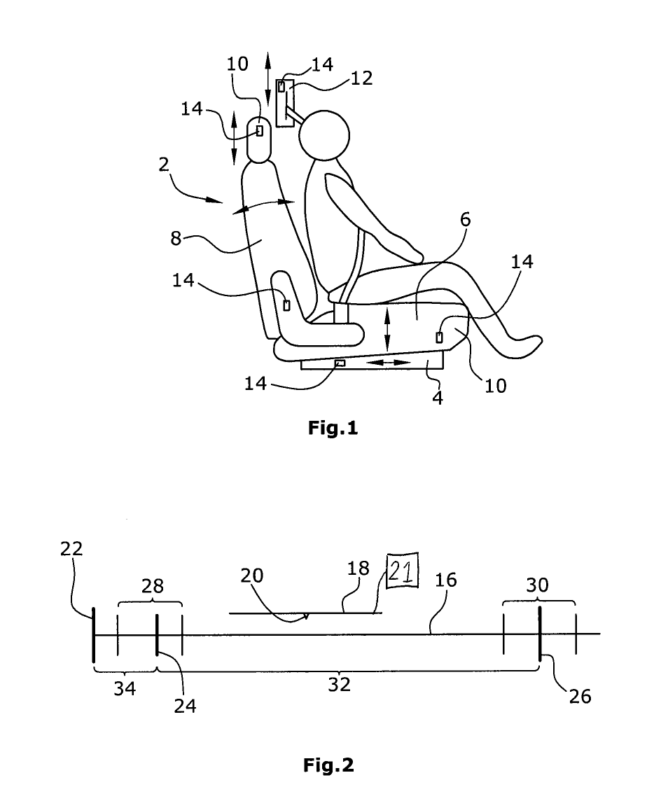

FIG. 1 shows an approved motor vehicle seat 2 with five adjustment devices, a longitudinal adjustment device 4, a vertical adjustment device 6, a backrest adjustment device 8, a headrest adjustment device 10 and a seatbelt adjustment device 12. Each adjustment device has an EC motor 14. The invention will be described in more detail below with reference to the longitudinal adjustment device 4.

FIG. 2 is a schematic view of a fixed guide element 16 on which an adjustment element 18 is movably arranged. The adjustment element 18 has in a known fashion a referencing element 20 for determining the position. An EC motor 14 (not illustrated in more detail) having a control unit and actuation means 21 (also referred to herein as an actuator) drives the adjustment element 18 here.

In the present case, the guide element 16 only has a mechanical end stop 22. Furthermore, referencing data, specifically a first end point 24 and a second end point 26, a first capture region 28 and a second capture region 30, an adjustment travel 32 and an end distance 34, are provided as a function of this mechanical end stop 22. In the normal customer operating mode, the adjustment element 18 of the longitudinal adjustment device 4 with its referencing element 20 can only be moved between the first end point 24 and the second end point 26, that is to say along the adjustment travel 32. The mechanical end stop 22 is not loaded and can accordingly be of a simple and lightweight design. In the present exemplary embodiment, the actuation means 21 are configured in such a way that when the adjustment element 18 and therefore the referencing element 20 are located in the capture region 34, the EC motor 14 can only be started in the direction of the end point 26. Even if the adjustment element 18 and its referencing element 20 are located in the capture region 30, it is only possible to start the EC motor 14 in the direction of the end point 24. In this context it is also particularly advantageous if the actuation means are configured in such a way that within a capture region 28, 30 the power of the EC motor 14 is limited in order to limit the activation force or the activation torque for moving the adjustment element 18 to a definable value.

If there are still no referencing data stored in the control unit (not illustrated) of the adjustment device 4, in the present case there is provision that the adjustment element 18 can only be operated with a limited speed since a power limitation is defined. This power limitation can be between 10% and 80%. The longitudinal adjustment device 4 is standardized as follows: First a referencing mode is selected in the control unit, the direction of rotation of the EC motor 14 is defined and stored for the referencing run, the adjustment travel 32 for the adjustment element 18 is defined and stored, the end distance 34 of the adjacent end point 24 with respect to the mechanical end stop 22 is defined and stored, and capture regions 28 and 30 are defined and stored for a referencing run. The referencing run of the adjustment element 18 and/or of the referencing element 20 is started by triggering an operator control switch. The adjustment element 18 is then moved with the referencing element 20 up to the mechanical end stop 22, as a result of which the EC motor 14 is blocked. The direction of rotation of the EC motor 14 is subsequently changed. The adjustment element 18 is then moved by the end distance 34. The referencing element 20 is then at the first end point 24. This first end point 24 is stored. The second end point 26 is also calculated by adding the previously defined adjustment travel 32 and stored. The capture regions 28 and 30 are assigned to the respective end points 24 and 26 and stored. The referencing run is then terminated. The longitudinal adjustment device 4 is then standardized. In one advantageous embodiment, it is also possible to provide that a power limitation is defined for reaching the mechanical end stop 22 during the referencing run, in order to reduce the loading of the mechanical end stop 22 even further.

In the case of re-standardization of the longitudinal adjustment device 4 it is possible to proceed as follows: the referencing run of the adjustment element 4 is re-started by triggering an operator control switch. The adjustment element 18 with the referencing element 20 is then moved up to the end point 22 and the EC motor 14 is switched off. The operator control switch is then activated at least once in the direction of the closest end stop 22. The adjustment element 18 of the referencing element 20 is then moved up to the mechanical end stop 22, as a result of which the EC motor 14 is blocked. The direction of rotation of the EC motor 14 is then changed. The adjustment element 18 is then moved by the end distance 34, with the result that the referencing element 20 then bears against the first end point 24. This end point 24 is in turn stored, and the second end point 26 is re-calculated on the basis of the adjustment travel 32 and also stored. The capture regions 28 and 30 are subsequently assigned to the respective end points 24, 26 and stored. The referencing run can then be terminated.

What is claimed:

1. An adjustment device in the automotive field, comprising:
a fixed guide element and an adjustment element which is movably arranged with respect thereto and which has a referencing element,
an EC motor which drives the adjustment element within an adjustment travel, and
a control unit with an actuator for the EC motor,
wherein the adjustment travel is bounded by a first end point and a second end point which are respectively arranged within a first and a second capture region,
wherein at least one mechanical end stop is provided which is arranged outside the adjustment travel.

2. The adjustment device as claimed in claim 1, wherein the actuator is configured in such a way that if the referencing element of the adjustment element is located in a capture region, it is possible to start the EC motor only in the direction of an opposite end point.

3. The adjustment device as claimed in claim 1, wherein the actuator is configured in such a way that power limitation of the EC motor is provided within the adjustment region.

4. A method for standardizing an adjustment device as claimed in claim 1, wherein no referencing data are stored, characterized by the following steps:
selecting a referencing mode in the control unit,
a direction of rotation of the EC motor, the adjustment travel for the adjustment element, an end distance of the adjacent end point from the mechanical end stop and the capture regions for the end points are defined and stored for a referencing run,
a referencing run of the adjustment element is started by triggering an operator control switch,
the adjustment element with the referencing element is moved up to the mechanical end stop, as a result of which the EC motor is blocked,
the direction of rotation of the EC motor is changed,
the adjustment element is moved by the end distance,
the first end point is stored,
the second end point is calculated on the basis of the adjustment travel and stored,
the capture regions are assigned to the end points and stored, and
the referencing run is terminated.

5. The method for standardizing an adjustment device as claimed in claim 4, wherein, if no referencing data are stored, a first power limitation for the entire referencing run is defined.

6. The method for standardizing an adjustment device as claimed in claim 5, wherein a second power limitation is defined for reaching the mechanical end stop.

7. A method for re-standardizing an adjustment device as claimed in claim 1, wherein referencing data are stored, characterized by the following steps:
a referencing run of the adjustment element is started by triggering an operator control switch,
the adjustment element with the referencing element is moved up to the end point and the EC motor is switched off,
the operator control switch is activated at least once in the direction of the closest end stop,
the adjustment element with the referencing element is moved up to the mechanical end stop, as a result of which the EC motor is blocked,
the direction of rotation of the EC motor is changed,
the adjustment element is moved by an end distance,
the first end point is stored,
the second end point is calculated on the basis of the adjustment travel and stored,
the capture regions are assigned to the end points and stored, and
the referencing run is terminated.
